(19) United States
(12) Patent Application Publication
(10) Pub. No.: US 2021/0274096 A1
(43) Pub. Date: Sep. 2, 2021

(54) OPTRONIC SIGHT AND ASSOCIATED PLATFORM

(71) Applicant: THALES, Courbevoie (FR)

(72) Inventor: Paul THIBOUT, Elancourt (FR)

(21) Appl. No.: 17/256,594

(22) PCT Filed: Jul. 1, 2019
(86) PCT No.: PCT/EP2019/067595

§ 371 Date: Dec. 28, 2020

(30) Foreign Application Priority Data
Jul. 2, 2018 (FR) 18/00684

(51) Int. Cl. H04N 5/232; H04N 5/225

(52) U.S. Cl. CPC H04N 5/23238; H04N 5/2327; H04N 5/23299; H04N 5/2258

(57) ABSTRACT

The present invention relates to an optronic sight comprising:
an optronic head,
a positioner which is capable of rotating the optronic head about a single rotation axis,
the optronic head comprising a set of optical sensors which are organized to form an asymmetrical field of view which is greater than or equal to 60° in a main direction and greater than 30° in the direction perpendicular to the main direction, the optical sensors comprising pixels which each have an instantaneous field of view, the number of pixels being such that the instantaneous field of view is less than 500 microradians and greater than 50 microradians.

The present invention relates to an optronic sight. The present invention also relates to a platform comprising such a sight.

The present invention relates to the field of optronic sights able to be installed on any type of platform.

For applications in particular for observation or tracking, it is desirable to be able to observe over a wide field both in elevation and in azimuth with a high resolution.

To this end, it is known to use two types of optronic sights: sights having mechanical scanning in elevation and in azimuth or sights having mechanical scanning in azimuth with a large optronic field, which are instead used for surveillance. Optronic sights of the first type can use a small field (or wide field) in elevation and in azimuth with a high resolution; sights of the second type have mechanical scanning in azimuth with a large optical field and therefore a low resolution, since they use only one detector to view the entire field.

Also known from document FR 2,833,086 A1 is a high-speed sectorial or panoramic optronic surveillance device without apparent movement, including a head with optical components and an optoelectronic detector, the head being sealed by a window and supported by an orientation mechanism. The head includes N stationary catoptric or catadioptric optical blocks arranged so that their optical exit pupils lie on a circle, these optical blocks being followed by a periscope that rotates about the axis of said circle and is itself followed by an optical focusing group and by an optoelectronic detector matrix.

Nevertheless, the use of such optronic sights does not make it possible to meet the need for high resolution while limiting the number of moving mechanical axes and to perform a simultaneous observation in high and low elevation.

There is therefore a need for an optronic sight making it possible to observe a wide field more quickly in elevation with a good resolution.

To this end, the present disclosure relates to an optronic sight comprising an optronic head, a positioner which is capable of rotating the optronic head about a single rotation axis, the optronic head comprising optical sensors which are organized to form an asymmetrical field of view which is greater than or equal to 60° in a main direction and greater than or equal to 30° in the direction perpendicular to the main direction, the optical sensors comprising pixels which each have an instantaneous field of view less than 500 microradians and greater than 50 microradians.

According to specific embodiments, the sight comprises one or more of the following features, considered alone or according to any technically possible combinations:
the number of pixels is such that the instantaneous field of view is greater than 50 microradians, preferably greater than 100 microradians, advantageously greater than 250 microradians.
the pixels of each optical sensor form a matrix of pixels, the number of pixels of the set being the sum of the number of pixels of each matrix decreased by the number of pixels for a matrix corresponding to the overlap of the fields, the optical sensors being stationary relative to one another and each having its own field of view, the field of view of the set being the sum of the fields of view of the optical sensors to within the overlap of the fields.
the set is adapted to operate in one or several different spectral bands.
at least two optical sensors are adapted to operate in the same spectral band.
each field of view of the same spectral band is formed by at least two optical sensors having a field overlap of between 1° and 3°.
each different spectral band field of view observes the same scene.
the main direction of the field of view of the set is parallel to the rotation axis.
the main direction of the field of view of the set is perpendicular to the rotation axis.
the set of optical sensors is organized to form a field of view greater than or equal to 90° in the main direction.
the set of optical sensors is organized to form a field of view greater than or equal to 60° in the perpendicular direction.
the optronic head has a parallelepipedal shape having end faces, at least one part of the faces being adapted to accommodate an additional module, such as a sensor or an effector.
the optronic head is adapted to operate according to two positions, a first position in which the main direction of the field of view of the set of optical sensors is parallel to the rotation axis and a second position in which the main direction of the field of view of the set of optical sensors is perpendicular to the rotation axis.
the optronic sight is provided with means for switching the optronic head between the two positions.

The present disclosure also relates to a platform including optronic sight as previously disclosed.

Other features and advantages of the invention will appear upon reading the following description of embodiments of the invention, provided as an example only and in reference to the drawings, which are:

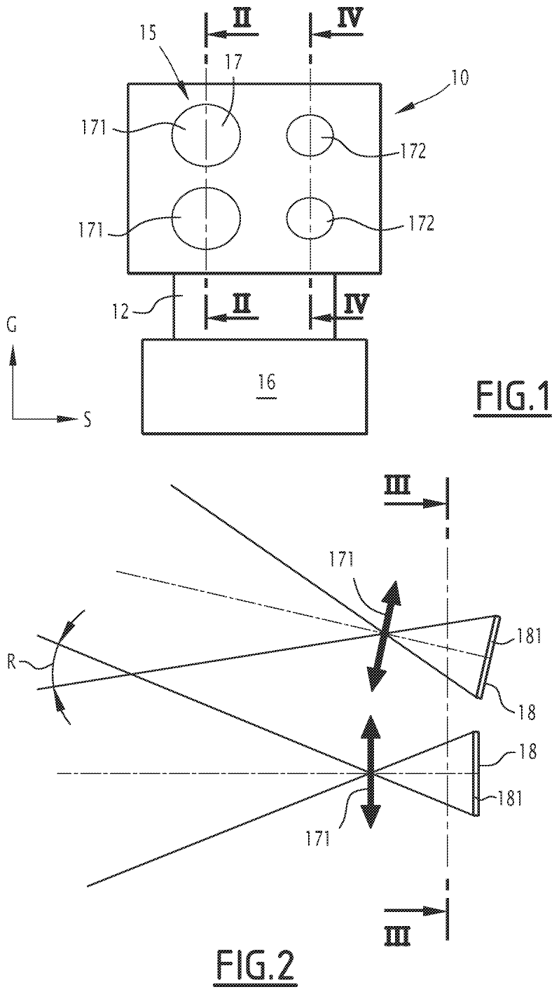

FIG. 1, a schematic view of an example sight;

FIG. 2, a schematic sectional view of the sight of FIG. 1 along the axis II-II indicated in FIG. 1;

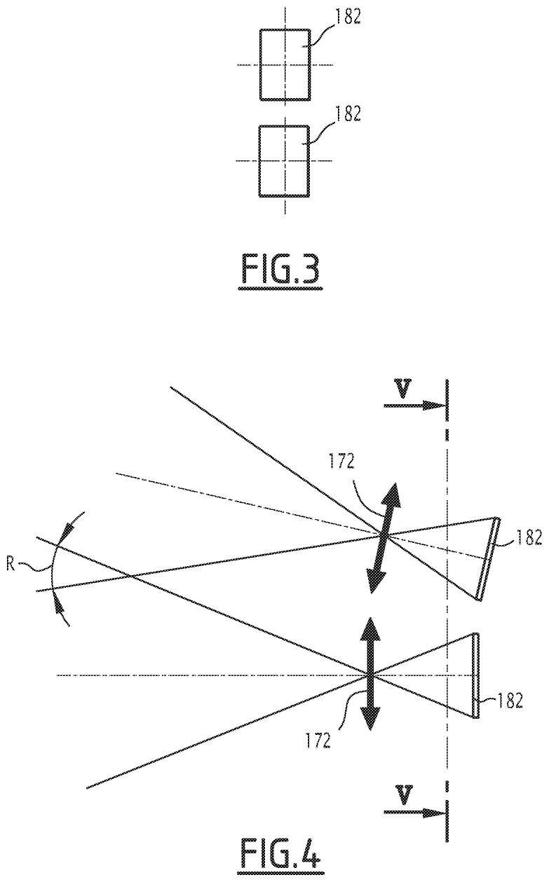

FIG. 3, a schematic sectional view of part of the sight in section along the axis III-III indicated in FIG. 2;

FIG. 4, a schematic sectional view of the sight of FIG. 1 along the axis IV-IV indicated in FIG. 1;

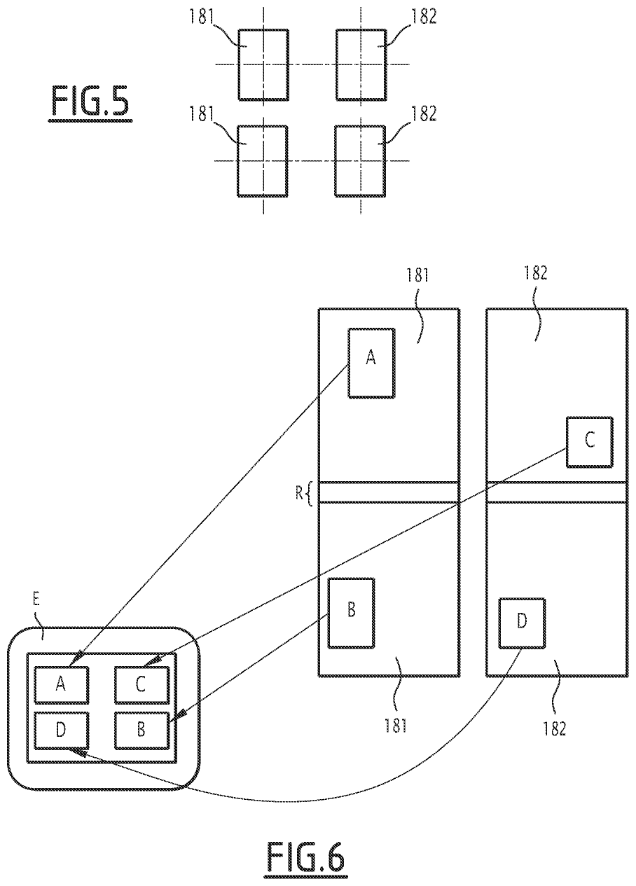

FIG. 5, a schematic sectional view of the sight of FIG. 1 in the plane of axes III-III and V-V indicated in FIGS. 2 and 4;

FIG. 6, a schematic view of reconstituted image strips obtained by the sight;

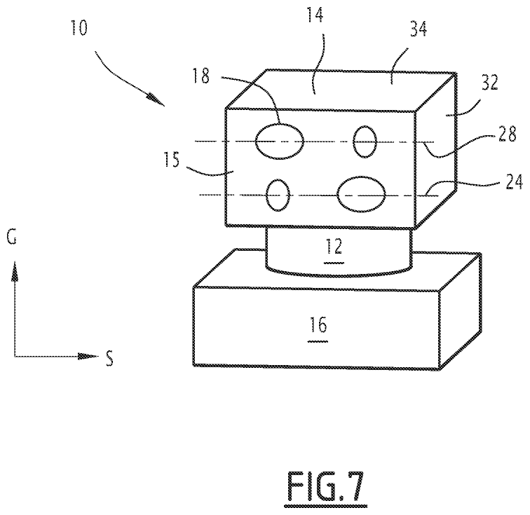

FIG. 7, a schematic view of another example sight; and

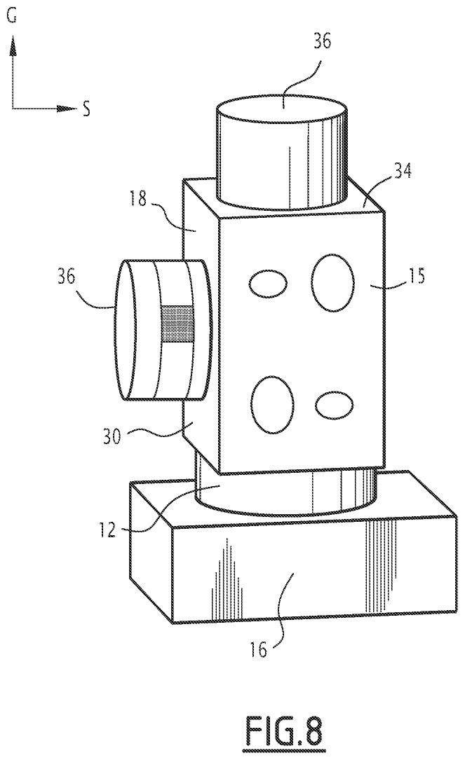

FIG. 8, a schematic view of still another example sight.

An optronic sight 10 is illustrated in FIGS. 1 to 5.

An optronic sight 10 is used to observe the environment.

In the case at hand, the optronic sight 10 is a peripheral sight, that is to say, adapted to view 360°.

The optronic sight 10 is further suitable for medium-range reconnaissance observations.

The optronic sight 10 includes a positioner 12, an optronic head 14 and a computer 16.

The positioner 12 is adapted to rotate the optronic head 14 about a single rotation axis.

In this context, “single” means that the positioner 12 is not movable about an axis other than the rotation axis.

In particular, if the positioner 12 is adapted to rotate the optronic head 14 according to a rotation in elevation, the positioner 12 is not adapted to rotate the optronic head 14 in azimuth.

According to one particular example, the positioner 12 is adapted to perform a rotation for example greater than +180° relative to a rotation axis and a rotation greater than −180° relative to the same rotation axis.

As a result, the positioner 12 is adapted to perform a rotation about a rotation axis by a total angle greater than or equal to 360°.

According to another example, the positioner 12 is adapted to perform a rotation equal to Nx 360° relative to the same rotation axis, N being an integer greater than or equal to 1.

The positioner 12 is for example a rotating support.

In the case of FIG. 1, the single rotation axis corresponds to the azimuth G. The optronic sight 10 makes it possible, in this configuration, to obtain images where the elevation to be covered is obtained instantaneously (in the main direction of the optical field) and the azimuth to be covered is obtained by rotation about the axis.

The optronic head 14 includes a set of optical sensors 15, called set 15 hereinafter.

The set 15 has an asymmetrical field of view. Along a main direction, it has a field of view greater than or equal to 60°, advantageously greater than 90°.

In the case at hand, for the orientation shown in FIG. 1, this means that the set 15 has, in elevation S, a field of view equal to 60° (advantageously greater than 90°).

The set 15 includes optics 17 and optical sensors 18, each optical sensor 18 comprising a matrix M of pixels, the number of pixels being such that the instantaneous field of view of each pixel is less than 500 microradians (μrad) and greater than 50 microradians.

The instantaneous field of view is the maximum angular radiation of a pixel. The instantaneous field of view is often referred to using the acronym IFOV.

The instantaneous field of view is measured in the object space of each optic 17.

This means that it is the optical sensors 18 themselves which will ensure that the condition on the instantaneous field of view of each pixel is respected and not a collaboration among several components (for example, an optic or a mirror) and the optical sensor 18 in question.

Furthermore, the condition on the instantaneous field of view of each pixel involves a large number of pixels, for example more than 1000 pixels, or even more than 2000 pixels.

Furthermore, the instantaneous field of view of each pixel is preferably greater than or equal to 200 μrad, or even greater than or equal to 250 μrad, in order to limit the sensitivity to movement during the integration time of the optical sensor 18. Such a condition on the instantaneous field of view makes it possible to make the set 15 less sensitive to the vibrations of outside components, in particular when a vehicle including the set 15 is stopped. In order to limit blurring even if the vehicle moves, it is possible to reduce the integration time of image acquisition so as to reduce blurring during the integration time and to increase the image rhythm so as to improve the sensitivity of the camera.

The set 15 is thus adapted to take images of the environment which are transmitted to the computer 16 via a link, for example a wired connection or by a fiber.

In general, the link is adapted to transmit data to the computer 16 such as information, images or a set of images forming a video.

The computer 16 is positioned below the positioner 12.

The computer 16 is thus positioned so as to be stationary, only the positioner 12 and the set 15 performing a rotation in azimuth G.

In such a case, it should be noted that the link between the computer 16 and the optronic sight 10 is devoid of rotating joint.

This makes it possible to reduce the complexity of the transfer of high throughput signals of the video type to the computer 16.

In a variant, the computer 16 is positioned on the positioner 12. In such a case, it is preferable for only the real-time processing functions to be applied on raw images.

The computer 16 is a system capable of performing computations, in particular to perform image processing.

During operation, the positioner 12 rotates the set 15 in azimuth G so as to acquire an image of the environment in real time.

A 360° image of the environment is thus obtained over an elevation S angle of 60° (advantageously 90°).

Such an optronic sight 10 makes it possible to observe a wide field in elevation S (at least 60°) and in azimuth with a fine angular definition (instantaneous field of view of each pixel is less than 500 μrad and greater than 50 μrad). More specifically, the optronic sight 10 makes it possible to observe several fields in elevation S, static or in motion. In the case of fields in motion, electronic stabilization is used.

In its initial configuration, the optronic sight 10 only uses a single mechanical rotation system without mechanical stabilization, the optronic sight 10 is easier to implement.

Of course, the optronic sight 10 is also compatible with mechanical stabilization if this is desired.

Further, due to the limitation of the setting in motion of the optronic sight 10, the optronic sight 10 is more robust and has a simpler design.

Additionally, the optronic sight 10 makes it possible to pass high throughputs, which allows a faster transfer of videos.

This also makes it possible for the optronic sight 10 to be devoid of rotating joint in azimuth G.

In summary, the optronic sight 10 makes it possible to observe a wide field more quickly in elevation and in azimuth with a good resolution.

Other embodiments can be considered for the optronic sight 10.

The set 15 is devoid of zoom. This makes it possible to obtain a set 15 which is easier to implement.

The sets 15 are preferably also not cooled for a similar reason.

In a variant or in addition, a field of view in elevation S greater than or equal to 60°, preferably greater than or equal to 90°. This makes it possible to obtain a greater angular observation span for the optronic sight 10.

One manner of obtaining such a field of view is to use several optical sensors 18, as shown in FIG. 1. In such a case, the set 15 includes optical sensors 18 each including a matrix M of pixels.

The matrices M of pixels are square or rectangular.

In the illustrated example, the matrices M of pixels are rectangular.

The number of pixels of the set 15 is the sum of the number of pixels of each matrix M decreased by the number of pixels for a matrix corresponding to the overlap of the fields. In the case at hand, this means that the sum of the number of pixels of each matrix M is such that the instantaneous field of view of each pixel is less than 500 microradians.

The optical sensors 18 are stationary relative to one another and each have their own field of view, the field of view of the set 15 being the sum of the fields of view of the optical sensors 18, to within the overlap of the fields.

In such a scenario, each optical sensor 18 is connected to the computer 16 by a respective link such that each optical sensor 18 corresponds to a channel.

The channels are independent of one another.

Further, the number of channels is relatively small.

As an illustration, the number of optical sensors 18 and therefore of channels is equal to 2, 3 or 4.

In the case of FIG. 1, the number of optical sensors 18 is four, namely two optical sensors 181 associated with a respective optic 171 and two optical sensors 182 associated with a respective optic 172.

Further, each field of view of an optical sensor 18 has a slight overlap with at least one other field of view of an optical sensor 18 of the same spectral band. In the described case, the overlap R corresponds to an angular overlap in elevation S. The overlap R is embodied in FIG. 2. Conversely, in azimuth, the sensors for each of the elevations observe the same image fields (there is therefore total overlap between the different spectral bands).

For example, the overlap in elevation between two fields of view of the same optical bandwidth (for example, uncooled infrared (band 8 to 12 microns) is between 1° and 3°. Conversely, the two uncooled infrared channels and the two visible channels overlap in azimuth.

Therefore, more strictly, the number of pixels of the set 15 is the sum of the number of pixels of each matrix M decreased by the number of pixels for a matrix corresponding to the overlap R of the fields. The overlaps R are visible in FIGS. 2 and 3.

Furthermore, the optical sensors 18 are aligned along the rotation axis. This means that by defining a center for each matrix M of pixels, the centers are aligned along a straight line which is parallel to the rotation axis.

For example, as shown in FIG. 3 or 5, for a field of view in elevation S of 60° for the optronic sight 10 with an overlap of 1°, it suffices to use two optical sensors 181 or 182 which are identical and which have a field of view in elevation S of 31° each with a number of pixels making it possible to have an instantaneous field of view of less than 500 μrad and greater than 50 μrad).

In such a case, an optical strip is thus formed of 60° in elevation S, for example between −15° and 45° relative to a reference direction for the uncooled infrared channel and identically for the visible channel, these two strips concerning the same image field. FIG. 6 makes it possible to illustrate how it is possible to choose, in this image in strip form, zones of interest A and B for the image made up of the sensors 181 and respectively C and D for the sensors 182.

According to another example, for a field of view in elevation S of 90° for the optronic sight 10 and an overlap of 1°, it suffices to use three optical sensors 18 which are identical and which have a field of view in elevation S of 31° each with a sufficient number of pixels for the second optical sensor 18 (intermediate sensor) to cover 1° in elevation S of each of the first and third optical sensors 18 (end sensors). In other words, the first optical sensor 18 and the second optical sensor 18 are superimposed over 1° while the second optical sensor 18 and the third optical sensor 18 are superimposed over 1°.

Each pixel then has an instantaneous field of view of less than 500 μrad and greater than 50 μrad.

In such a case, an optical strip is then formed of 90° in elevation S, for example between −15° and 75° relative to a reference direction.

According to the embodiment illustrated by FIG. 7, the optical sensors 18 are arranged in two rows 24 and 28.

This means that the centers of each optical sensor 18, that is to say the centers of each matrix M of pixels, are aligned in a respective row.

The lines 24 and 28 are preferably parallel.

This in particular makes it possible to consider configurations with at least two spectral bands for the set 15.

By definition, when the set 15 is bispectral, at least one optical sensor 18 is adapted to operate according to a different spectral band from another spectral band on which another optical sensor 18 is adapted to operate. The definition is immediately generalized to a case with more spectral bands.

It should also be noted that other embodiments are compatible during operation with several spectral bands, including that which has just been presented.

In the case of FIG. 8, the optical sensors 18 of a same row 24, 28 are adapted to operate according to a different spectral band, as appears with the different form of the optical sensors 18.

According to another variant, the optical sensors 18 of the same row 24, 28 are adapted to operate in the same spectral band.

According to a more elaborate variant, the optical sensors 18 share a same optic for different spectral bands.

For example, the optical sensors 18 of the first row 24 operate in the near infrared, while the optical sensors 18 operate in the visible.

Other spectral bands are also usable in this context. In general, the spectral bands are chosen among the following bands:
the near infrared (which encompasses the wavelengths between 0.74 micrometers (μm) and 1 μm and which is also referred to using the acronym NIR),
the visible (which encompasses the wavelengths between 0.4 μm and 0.8 μm),
the band of the short-wavelength infrareds (which encompasses the wavelengths between 1 μm and 3 μm and which is also referred to using the acronym SWIR),
the band of the medium-wavelength infrareds (which encompasses the wavelengths between 3 μm and 5 μm and which is also referred to using the acronym MWIR),
the band of the long-wavelength infrareds (which encompasses the wavelengths between 8 μm and 12 μm and which is also referred to using the acronym LWIR),

According to another embodiment shown by FIG. 8, the optronic head 14 has a parallelepipedal shape (in particular cubic) having end faces, only three of which 30, 32 and 34 are visible in FIGS. 7 and 8, at least part of the end faces 30, 32 and 34 being adapted to accommodate an additional module 36.

For example, an additional module 36 is a radar, a lidar, a telemeter, a three-dimensional sensor, a sonar or another optical sensor 18 including matrices M of pixels.

Alternatively or additionally, an additional module 36 is an effector.

In the case of FIG. 5, one end face 32 includes a lidar and one end face 34 includes an optical sensor 18.

The parallelepipedal shape further makes it possible to easily implement a 90° rotation making it possible to go from the elevation field to the azimuth field either manually or by a motorized 90° rotation (that is to say in the latter case the telemeter will remain fixed on a base rigidly maintained on the azimuth axis G).

In such a case, the optronic head 14 is adapted to operate according to two positions, a first position in which the main direction of the field of view of the set of optical sensors is parallel to the rotation axis and a second position in which the main direction of the field of view of the set of optical sensors is perpendicular to the rotation axis. When the passage from one position to the other is not done manually, the optronic sight 10 is provided with means for switching the optronic head between the two positions.

According to another embodiment, the computer 16 is adapted to perform specific processing operations.

For example, the computer 16 uses the transmitted data to perform stabilizations of the images and derotations of the images. In particular, the computer 16 is adapted to stabilize the images of the set 15 in azimuth G and in elevation S. The electronic stabilization is done by integration of data coming either from gyrometers, or by analysis of the images, or by both at the same time.

According to another example, the computer 16 is adapted to implement an electronic zoom.

According to still another embodiment, a line of sight is defined and the positioner 12 is adapted to stabilize the line of sight. The line of sight is thus mechanically stabilized in azimuth G.

According to still another embodiment, the optical sensors 18 have rectangular matrices M having a maximum width parallel to the elevation S.

It should also be noted that the sets 15 can cover fields in elevation S with the maximum width parallel to the azimuth G depending on the need.

In a variant, the positioner 12 is suitable for rotating the optronic head 14 in elevation S instead of in azimuth G.

The optronic sight 10 is usable for applications requiring instantaneous visibility over a wide field with good definition on a static and dynamic platform.

In particular, for the case of cannon shots with a high rate, it becomes possible to keep an image governed by the axis of the canon or any other reference and an image on the target.

Such optronic sights 10 are adapted to be installed on any type of platform having a need to observe a wide field in elevation (at least 30°) and in azimuth G with a very fine angular definition, this need having to be met with an optronic sight 10 that is easy to implement.

A land-based vehicle is one example of a platform.

It should be noted that, in the specific case of a tank, the obtained performance depends on the considered spectral band.

For example, for a set 15 operating in the visible, an instantaneous field of view each [sic] pixel is 250 μrad and the RECO range measured using a Johnson sight on the tank will be of the order of 2000 meters (m). For a set 15 operating in the near infrared, an instantaneous field of view for each pixel is 400 μrad and the RECO range measured using a Johnson sight on the tank will be of the order of 1000 m.

In a variant, the platform is an air or naval platform.

In each of the illustrated cases, the platform is mobile, but nothing precludes the use of the optronic sight 10 for a stationary platform.

Other embodiments may be considered, these embodiments resulting from any technically possible combination of the preceding embodiments.

1. Optronic sight including:
an optronic head,
a positioner adapted to rotate the optronic head about a single rotation axis,
the optronic head comprising a set of optical sensors which are organized to form an asymmetrical field of view which is greater than or equal to 60° in a main direction and greater than 30° in the direction perpendicular to the main direction, the optical sensors comprising pixels which each have an instantaneous field of view, the number of pixels being such that the instantaneous field of view is less than 500 microradians and greater than 50 microradians.

2. Optronic sight according to claim 1, wherein the set of optical sensors is organized to form a field of view greater than or equal to 90° in the main direction.

3. Optronic sight according to claim 1, wherein the set of optical sensors is organized to form a field of view greater than or equal to 60° in the perpendicular direction.

4. Optronic sight according to claim 1, wherein the number of pixels is such that the instantaneous field of view is greater than 200 microradians.

5. Optronic sight according to claim 1, wherein the pixels of each optical sensor form a matrix of pixels, the number of pixels of the set of optical sensors being the sum of the number of pixels of each matrix decreased by the number of pixels for a matrix corresponding to the overlap of the fields, the optical sensors being stationary relative to one another and each having its own field of view, the field of view of the set of optical sensors being the sum of the fields of view of the optical sensors taking into account the overlap of the fields.

6. Optronic sight according to claim 5, wherein each field of view of an optical sensor has an overlap with at least one other field of view of an optical sensor in the main direction.

7. Optronic sight according to claim 6, wherein the field overlap is between 1° and 3° in the main direction.

8. Optronic sight according to claim 1, wherein the main direction of the field of view of the set of optical sensors is parallel to the rotation axis.

9. Optronic sight according to claim 1, wherein the main direction of the field of view of the set of optical sensors is perpendicular to the rotation axis.

10. Optronic sight according to claim 1, wherein at least two optical sensors are adapted to operate in the same spectral band.

11. Optronic sight according to claim 1, wherein the set of optical sensors is adapted to operate in at least two different spectral bands.

12. Optronic sight according to claim 1, wherein the optronic head has a parallelepipedal shape having end faces, at least one part of the faces being adapted to accommodate an additional module.

13. Optronic sight according to claim 1, wherein the optronic head is adapted to operate according to two positions, a first position in which the main direction of the field of view of the set of optical sensors is parallel to the rotation axis and a second position in which the main direction of the field of view of the set of optical sensors is perpendicular to the rotation axis.

14. Optronic sight according to claim 13, wherein the optronic sight is provided with a switching unit adapted to switch the optronic head between the two positions.

15. Platform including an optronic sight, the optronic sight being according to claim 1.

16. Optronic sight according to claim 4, wherein the number of pixels is such that the instantaneous field of view is greater than 250 microradians.

17. Optronic sight according to claim 12, wherein the additional module is a sensor or an effector.
